(19) United States
(12) Patent Application Publication
(10) Pub. No.: US 2002/0162032 A1
(43) Pub. Date: Oct. 31, 2002

(54) Method, system and computer program for load management

(76) Inventors: Lars S. Gundersen, Oslo (NO); Jan O. Gjerde, Oslo (NO); William H. Quaintance, Apex, NC (US); Khoi Vu, Apex, NC (US)

Correspondence Address: BIRCH STEWART KOLASCH & BIRCH, PO BOX 747, FALLS CHURCH, VA, 22040-0747, US

(21) Appl. No.: 09/793,589

(22) Filed: Feb. 27, 2001

(51) Int. Cl. G06F 1/26; G06F 1/28; G06F 1/30

(52) U.S. Cl. 713/300

(57) ABSTRACT

The invention concerns a system, a method, and a computer program product for load management in an electrical power generation, transmission and distribution network. A device arranged at a load point comprises means for a procedure call that may be remotely invoked in order to switch on or off a part load of an end user for the purpose of load demand management. The invention enables load to be reduced incrementally and restored quickly and automatically. The invention is carried out in part by a computer program product. The invention advantageously uses web technology to provide a power network with automated load management in an economic way. In a power network, the invention spreads the load shaving more evenly over a wide geographical area, as opposed to the traditional method of “rotating blackouts.”

### TECHNICAL FIELD

The present invention relates to supervision and control of an electrical power generation, transmission and distribution network. In particular the present invention discloses a method, a system and a computer program product for controlling and regulating electrical loads connected to an electrical network.

### BACKGROUND ART

The consumption of electricity is increasing worldwide; however, installing new large-scale distribution, transmission and/or generation capacity has become increasingly difficult. This is due to factors including increased load on the environment in the form of CO₂ emissions and to an unwillingness to invest in a de-regulated and/or fast-changing market.

Generation, transmission, and distribution capacity is dimensioned according to peak load, with extra capacity in generation and transmission to handle likely unplanned outages. Most systems have huge variations in load over a 24-hour period. The primary network components, such as cables, lines and transformers, must all be designed to withstand the peak load of the system, which peak only occurs for a few percent of the time. For an average utility, off-peak load is around one third of the peak load. A known approach to meet load demand is through peak-shaving of the load curve, i.e. Demand Side Management (DSM). This is intended to increase the efficiency of the electrical power system, and thereby defer investments in distribution, transmission and/or generation capacity.

U.S. Pat. No. 4,264,960 describes a method and apparatus which permits a power utility to have direct control over customers' loads for facilitating a load management philosophy including load shaving and load deferral. The system includes a master station and a plurality of remote receiver units positioned at, and connected to control the on and off times of, customer loads. The remote receiver units are controlled by signals from substations consisting of pulse code signals injected into the power network lines.

U.S. Pat. No. 4,686,630 describes a load management control system and method which communicates load shedding information from a central station controller via existing telephone lines to a substation controller. The substation controller sends encoded step voltage signals down a power line to a load control receiver.

Systems and methods for power management including load shaving often have a drawback in that one or more sets of specially designed devices are required to be connected to high voltage parts of a power network in order to encode and decode communication signals. Existing systems for automatic load management also often require one or more separate communications infrastructures, and many of them are time- based. However, if for example a peak load occurred at an unexpected time of day, the time-based system may have failed to reduce or smooth the load.

A well known drawback with existing power management systems based on load shedding is that upon restoration of power, the magnitude of the load to be re-connected is, in practice, unknown. In consequence, restoration after load shedding tends to take a long time. Loads that have been shed have to be re-energised in a predetermined way, one-by-one under careful monitoring, to avoid creating new disturbances in the power network that would lead to new problems, and possibly to further load disconnections.

Some recent systems have improvements based on Internet communication and/or standards associated with the Internet. U.S. Pat. No. 5,862,391 describes an extensive power management system comprising computers equipped for bus communication over a Modbus fieldbus connected to one or more DDE servers (Dynamic Data Exchange). The computers contain various software packages involved in monitoring and controlling selected aspects of power usage/consumption. Communications are described using TCP/IP (Transmission Control Protocol/Internet Protocol) via Ethernet LANs (Local Area Networks). Field devices such as a General Electric EPM3720 consumption meter unit are described as being continuously polled by the DDE server to carry out power management functions using Modbus RTU protocol.

EP 814 393 A1 describes use of the Internet as a part of a method to communicate with electrical components, principally appliances in the home, for the purpose of supervision and control. The method requires an intelligent socket to be added to each appliance together with the use of signals superimposed on a power distribution network to communicate control signals.

### SUMMARY OF THE INVENTION

It is an object of the invention to provide a method and system for regulation of one or more loads in a power generation, transmission and distribution network by means of secure control signals in a modern communications protocol compatible with the world wide web and other Internet technologies. This and other objects are realised by a method according to claim 1, a system according to claim 22, a computer program product according to claim 42 and a data communication signal according to claim 37. The invention may be described as a method to supervise and control an electrical power generation, transmission and distribution system, by means of an automated load management system, in which load shaving or load shedding actions are carried out by a device arranged at one or more load points. The load shaving decisions are calculated in part by use of reference information about each load stored for each load point device in the system. The load point device in a preferred embodiment is arranged so as to be able to implement a procedure call that has been remotely invoked for control purposes, which remote procedure call is made according to an open standard protocol, preferably SOAP (Simple Object Access Protocol) or another protocol preferably based on XML (extensible markup language).

A device at the load point exposes a set of web services, for example as remote methods implemented compatible with SOAP. One such service could be named curtailInterruptibleLoad( ) or curtailAllLoad( ). Authenticated users of this service can then call the remote method for example to be able to reduce load sufficiently in order to achieve peak shaving. An authenticated user connected to the electrical power generation, transmission and distribution system could be a substation automation system or device, a distribution automation system, a human operator, or other. The requirement to reduce load may be derived for example from reasons such as that:

the measured load in a substation has reached some limit,

an algorithm has detected that the power system is near voltage collapse,

the price of electricity has reached a financial limit,

the energy supply is exhausted.

The invention also provides for load restoration, which is also carried out by the device arranged at one or more load points.

The load restoration decisions are calculated in part by use of reference information about each load stored for each load point device in the system. The effect of one or more load restoration actions is to provide an incremental restoration of load in known increments.

The invention is in part carried out by means of a computer program product as described in patent claim 43. The computer program product is also summarily described here as comprising software portions and or computer program code elements for carrying out the steps and algorithms suitable for carrying out steps and calculations of the method according to the invention.

The main advantage of the invention is that management of electrical power demand in an electrical power system may be automated using open-standard web technology. The web technology is not dependent on any one computer type and is therefore platform-independent giving the additional advantage that it may be used in a system with equipment that includes different computer platforms. This technology is inexpensive to purchase, easily installed, easily interchanged, and permits the economic automation of, for example, medium voltage networks including smaller or isolated feeder systems and similar installations.

Certain economic advantages of the invention arise in part because special hardware devices for encoding or decoding signals to and from high voltage lines are not required. Other economic advantages arise from the use of web technology enabling use of lower priced open standard software in place of proprietary software.

Another and important advantage of the invention lies in that restoration of loads that have been disconnected by load shaving according to the invention may be restored in a fast and secure manner by the system for load management according to the invention. This is because the magnitude of the shaved load to be restored is known and so the maximum electrical power demand upon restoration of the shaved load is also known. Thus automatic calculations may be performed to allow restoration of loads that have been shaved to proceed automatically as soon as the relation between power demand and power available in the network reaches a predetermined value. This advantage also makes power management systems according to the invention more acceptable to end users in political terms because a smooth restoration of higher electrical loads is enabled without the long delays associated with restoration of power after blackouts (power cuts).

A further advantage is that existing power distribution systems may be simply and economically retrofitted with load point device equipment and computer program products according to the invention.

### BRIEF DESCRIPTION OF THE DRAWINGS

The present invention will be described in more detail in connection with the enclosed schematic drawings.

FIG. 1 shows a simplified diagram of different functional levels of power generation, transmission networks, primary and secondary distribution networks, and end users.

FIG. 2 shows a simplified diagram of functions in a power generation, transmission and distribution network, and residential, commercial and industrial end users, all connected via the Internet.

FIG. 3 shows a simplified and hierarchical diagram of medium voltage and high voltage equipment and functions, and of power distribution to residential, commercial and industrial end users in a power network.

FIG. 4a shows a simplified line diagram of residential end users connected to a distribution part of a power network arranged with a load point device according to an embodiment of the invention. FIG. 4b shows a corresponding simplified line diagram for an industrial end user connected to a distribution part of a power network arranged with a load point device according to an embodiment of the invention.

FIG. 5 shows a block diagram for a schematic representation of Smart Appliances and Legacy Appliances connected to an electric power grid according to an embodiment of the invention.

FIG. 6 shows a flow chart for a method carried out by a computer program product according to an embodiment of the invention.

FIG. 7 shows a schematic diagram of a format of a data communication signal.

### DESCRIPTION OF THE PREFERRED EMBODIMENTS

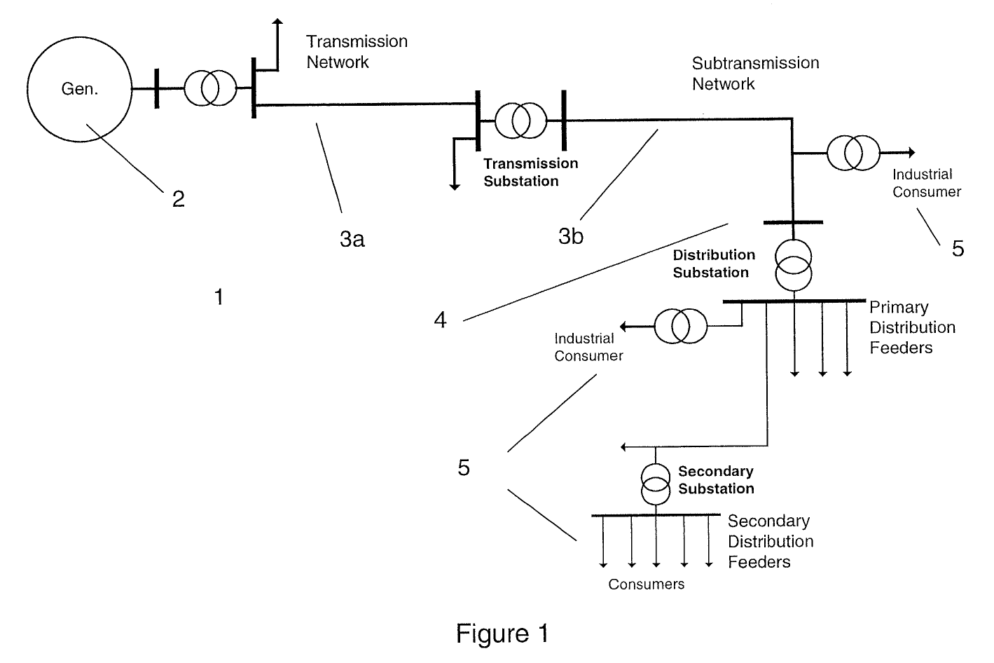

FIG. 1 shows a network 1 for electrical power generation, transmission and distribution. The electric power network 1 includes a generation facility 2, a transmission section 3a, a subtransmission network 3b, a distribution section 4, and a plurality of end-users 5.

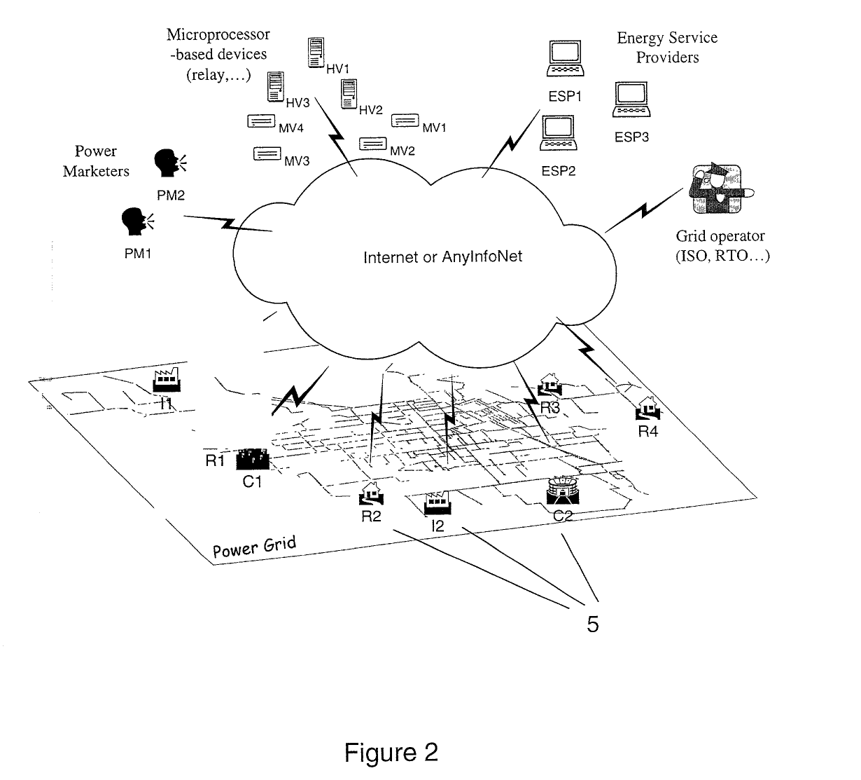

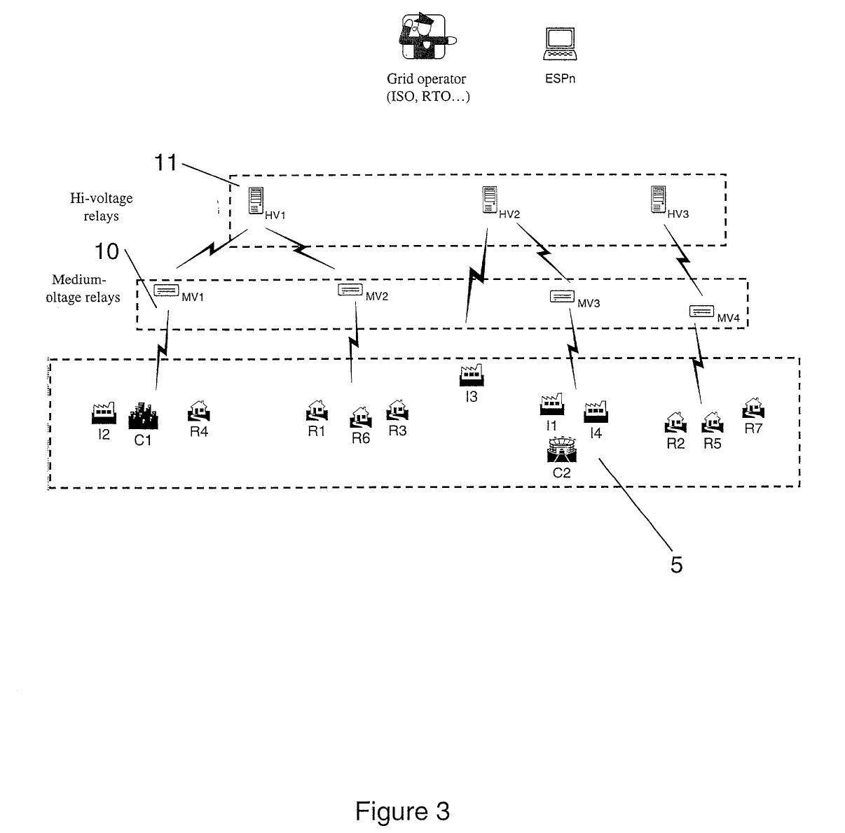

FIG. 2 shows end users 5 in a conceptual diagram with other functions of, and participants in, a power network, including a network operator such as an ISO (Independent System Operator). FIG. 3 shows a plurality of high voltage relays 11 and medium voltage relays 10 and a plurality of end users 5. The end users shown are intended to represent all possible end users and show residential users R1-R7, commercial users C1-C2 and industrial users I1-I4 as examples of end users. FIG. 3 illustrates the order in which a load-control command propagates from the highest level (e.g., grid operator) to the lowest level (end users).

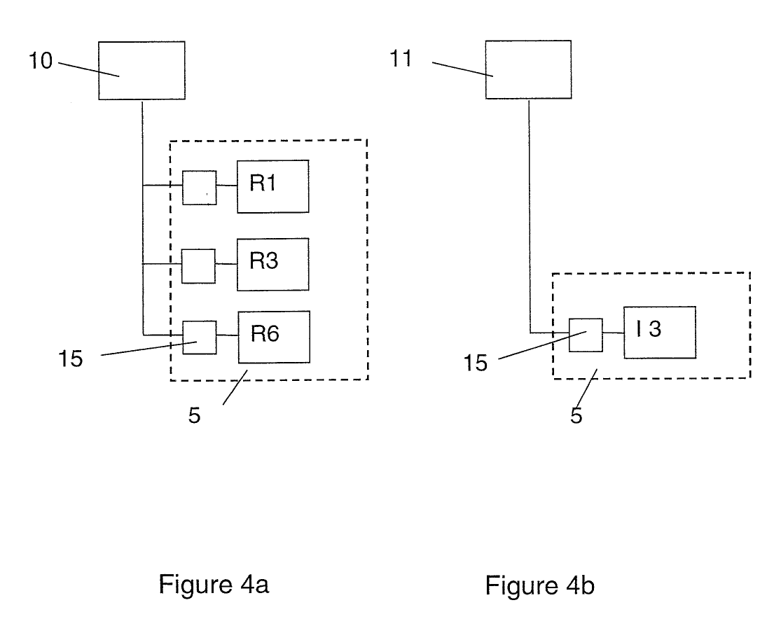

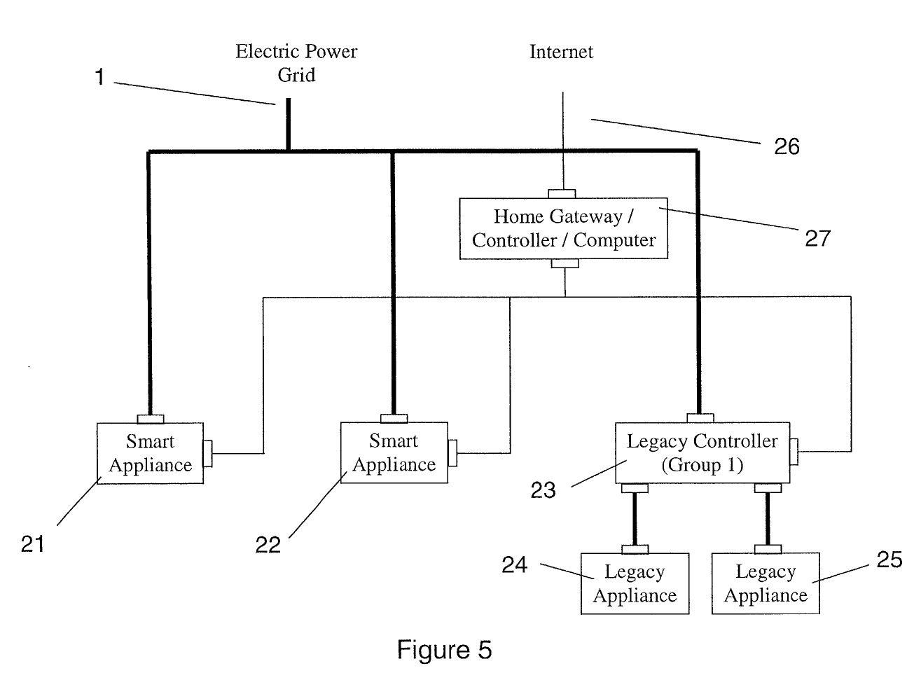

FIG. 4a illustrates a plurality of residential end users 5, detailed as end users R1, R3 and R6 each arranged connected to a medium voltage distribution network controlled by load point devices 15. FIG. 4b shows a corresponding arrangement for an industrial end user, I3, arranged as an end user 5 connected by a load point device 15 to a high voltage distribution line. The load point device 15 is arranged at a convenient supply connection point of an end user such as a residential, commercial or industrial user. The load point device may include a computer, a processor, a controller of the PLC (Programmable Logic Controller) type, an embedded controller or any combination of the above. FIG. 5 shows an electric power grid 1 including smart appliances 21, 22, legacy appliances 24, 25, and a legacy controller 23 and a communications unit such as a home gateway, controller or computer 27. The term smart appliance is used here to mean an appliance arranged for example with communication means so that can receive a data signal, typically sent via the Internet, so as to monitor or to regulate in some way the appliance. In FIG. 5 the smart appliances and the legacy controller are connected to the Internet. The Home Gateway 27 may be any communications unit with the ability to route communications from the Internet to and from the smart appliances and/or for the legacy controller. As such the home gateway function may be carried out by a computer, a set top box for a TV, computer game console unit such as Microsoft's X-Box (Trade Mark) or Sony Playstation (Trade Mark), other Internet enabled products including so-called “surf boards”, Internet surfing and e-mail devices such as a Sony Airboard (Trade Mark) or Ericsson's H610 Webscreen (Trade Mark). The smart appliances comprise the functions of a load point device, meaning that the smart appliances can receive a control signal via a data network and the Home Gateway 27 and implement a function in response to the signal. A smart appliance may be configured so that the incoming control signal can invoke a remote procedure call in the smart appliance to switch off a load or to restore a load.

The legacy controller can carry out the functions of a load point device such as 15 represented in FIG. 4a, 4b. The legacy controller receives a control signal invoking a procedure remotely, causing the load point device to switch off or switch on a load such as legacy appliances 24, 25 connected to it.

The function of the load point device is best carried out by a device at the load point that exposes a set of web services, for example as remote methods implemented in the Simple Object Access Protocol (SOAP). One such service could be named curtailInterruptibleLoad( ) or curtailAllLoad( ). Authenticated users of this service can then call the remote method for example to be able to achieve peak shaving. An authenticated user could be a substation automation system or device, a distribution automation system, a human operator, or other.

The requirement to reduce load may be derived for example from reasons such as that:

the measured load in a substation has reached its capacity limit,

an algorithm has detected that the power system is near voltage collapse,

the price of electricity has reached a financial limit,

the energy supply is exhausted.

Load Shaving

A hypothetical example of management of electrical power demand for a region such as in the state of California will be described to explain one way in which the invention may be carried out. On a very hot day in California the peak demand may be expected to hit 49 GW. Suppose that a fraction of the generating capacity is not available. Assume, for example, that generation breakdowns in the generation system have reduced the generating capacity to 47.5 GW. At a given moment with demand about to surpass supply, the wholesale price of electricity would go through the roof, and the grid will become electrically unstable.

However, instead of issuing a rotating blackout, or “Stage Three” emergency, a grid operator such as the ISO (Independent System Operator) shown in FIGS. 2,3, may decide to initiate a method to manage power demand according to the invention. The ISO reduces the power consumption by applying rationing evenly across the Californian population. On average, each consumer is trimmed by only 10%, yet the aggregated effect is great because approximately 5 GW is trimmed from the total 49 GW peak demand. The result of such an action would be that within minutes the control consoles of the grid would show that the total demand had dropped to 44 GW, leaving enough capacity margin for reliable operation. In this way the grid operator, the ISO, can ration the power demand effectively and still fulfil the sacred “obligation to serve” every customer.

A detailed example of a control action for load management implemented in an incremental way according to the invention is as follows. In this example the control action includes a fixed percentage load change. Each manageable load or controllable load may be arranged so that load shaving may be carried out in a way to cause minimal inconvenience to end users. This is achieved by taking into account a priority rating for each load. The priority rating of each controllable load is preferably designated by the end user. The priority assigned to each load and other information is arranged accessible in a reference means such as a Consumption Table, described below. The Consumption Table may be stored locally in the load point device or in another local device, such as for example the Home Gateway 27, or stored at any other location accessible by communication means operating open standard protocols such as Ethernet or TCP/IP.

By way of example, each controllable object has a priority, a real-time demand (kw), and an on/off status. Please refer to Table 1 in which the Consumption Table (TAB) is shown.

TABLE 1
Consumption Table TAB. (kWtotal = 5.6 kW)

| Object | Priority | kW | Status |
|---|---|---|---|
| Group_1 | 3 | 1.5 | 1 |
| Smart_appliance_1 | 2 | 0.3 | 1 |
| Smart_appliance_2 | 1 | 0.1 | 1 |
| Group_2 | 1 | 2.4 | 1 |
| Group_3 | 3 | 1.3 | 1 |
| Smart_appliance_3 | 2 | 1.4 | 0 |

The table shows a setting for the priority:

1 is the most important load and,

3 is the least important load.

The table also shows a value for status:

1 means on-line,

0 means off-line by choice, and

−1 means forced off-line by load reduction request.

TABLE 2
Consumption Table TAB changes dynamically to
reflect the total consumption:

| Object | Priority | kW | Status |
|---|---|---|---|
| Group_1 | 3 | 2.1 | 1 |
| Smart_appliance_1 | 2 | 0.3 | 0 |
| Smart_appliance_2 | 1 | 0.1 | 1 |
| Group_2 | 1 | 1.7 | 1 |
| Group_3 | 3 | 1.3 | 1 |
| Smart_appliance_3 | 2 | 1.4 | 0 |

Table 2 shows how the kW demand and status are updated in real time.

The Table depicting Consumption changes dynamically to reflect the total consumption: in this case more loads are added to

Group_{—}1; some load is disconnected from Group_{—}2; and

Smart_appliance_{—}1 is powered off.

In Table 3, a load reduction request, switch(30%, −1) has been received, and applied to the values shown in Table 1. In the switch signal received,

−1 means reduce load, and

30% specifies by how much the load shall be reduced.

TABLE 3
When switch (30%, −1) is applied to Table 1.

| Object | Priority | kW | Status |
|---|---|---|---|
| Group_1 | 3 | 1.5 | 1 |
| Smart_appliance_1 | 2 | 0.3 | −1 |
| Smart_appliance_2 | 1 | 0.1 | 1 |
| Group_2 | 1 | 2.4 | 1 |
| Group_3 | 3 | 1.3 | −1 |
| Smart_appliance_3 | 2 | 1.4 | 0 |

The reduction required at this load point is then 30% of 5.6 kW=1.68 kW. Starting with priority 3 loads, Group_{—}3 is tripped off-line because Group_{—}1+ another load would be too great a reduction. As a reduction of 0.38 kW still has to be made, priority 2 loads are examined next. Smart_appliance_{—}1 is approximately the right amount of load, and it is tripped. Demand kW for off-line equipment is shown as the last on-line value. Consumption for Table 3 after load shaving by 30% is 4 kW, which may be determined from the table by summing the kW consumption figures for loads showing status=1, which is 1.5+0.1+2.4=4 kW

In Table 4, an example of a load restoration action is illustrated according to another aspect of the invention. The previous load reduction is partially cancelled, by means of a signal such as switch(10%,+1). The information in the signal comprises:

+1 which means to restore load;

10% which specifies by how much the load is to be changed (restored in this case). However, it is pre-determined that only loads with a −1 status may be switched on.

Smart_appliance_{—}1 is approximately the right size and is restored to service.

TABLE 4
When switch (10%, +1) is applied to Table 3. Since
kWtarget = 10%*4 kW = 0.4 kW, Smart_appliance_1 is
chosen to be turned on.

| Object | Priority | kW | Status |
|---|---|---|---|
| Group_1 | 3 | 1.5 | 1 |
| Smart_appliance_1 | 2 | 0.3 | 1 |
| Smart_appliance_2 | 1 | 0.1 | 1 |
| Group_2 | 1 | 2.4 | 1 |
| Group_3 | 3 | 1.3 | −1 |
| Smart_appliance_3 | 2 | 1.4 | 0 |

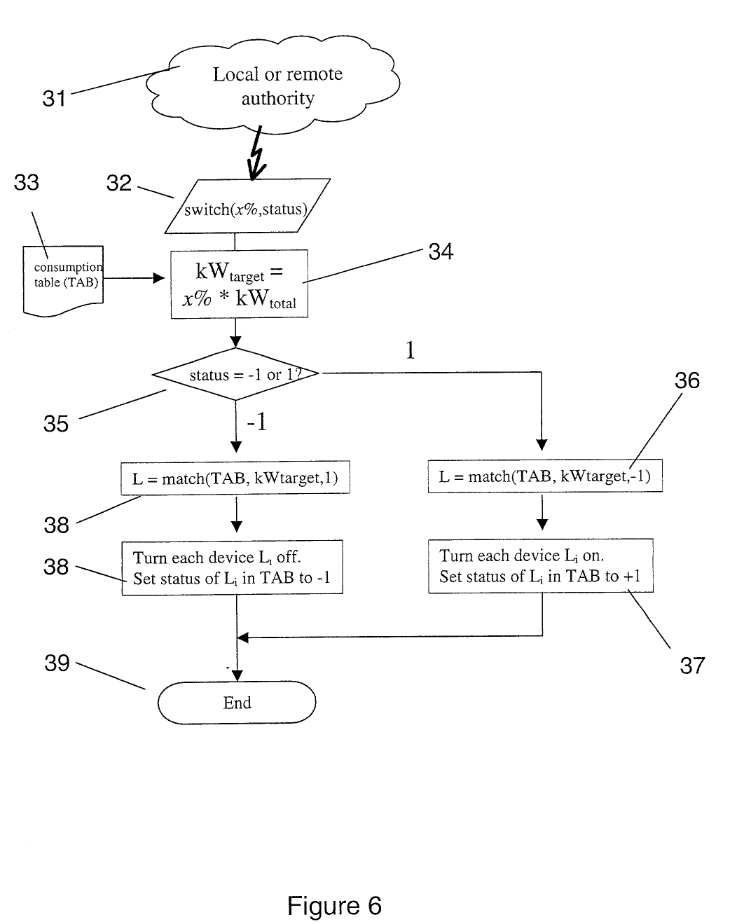

Consumption after the restoring part of the load in an incremental fashion in Table 4 results in a consumption of 1.5+0.3+0.1+2.4=4.3 kW, slightly under the restoration limit in this example. By this means, restoration of loads shed by a previous action only may be re-connected, so that the maximum increase in electrical load due to restoration is known. FIG. 6 shows a signal 32 received from a local or remote authority 31. A switch signal 32, essentially the switch signals described for the Consumption Table example above, is shown. Reference data for a load point device, Consumption Table 33 is shown connected and accessible to a calculation step 34 for calculating a kW reduction or restoration target based on switch signal 32. A decision step 35 is shown.

When the switch signal shows −1 a reduction is signalled and the method proceeds from step 35 to step 38 where loads are matched or selected in priority order to match the calculated target kwtarget to be shaved. In step 39 signals are issued to turn off the selected devices, and the status of the selected devices is then changed in the Consumption Table to show −1 thus recording that those loads have been disconnected by a load management action.

When the switch signal shows 1 a restoration is signalled and the method continues instead from step 35 to step 36 in which loads are matched or selected in priority order to match the kW target to be restored. This is followed by issuing signals to turn on each selected device, and then to re-set device status in the Consumption Table +1, both events in step 37.

The above example of a control action is for a load change of a fixed percentage of the current load. Other control actions may be implemented by the load management system. The operator may manually or automatically send a command that includes another function of the load, including a function such as any of a: -Percentage load change. A command to decrease or restore load by a specific percentage, as above, or a percentage range (e.g. decrease load by 10%, restore 50-60% of previously reduced load).

Kilowatt Load Change.

A command to decrease or restore load by a specific kilowatt amount or a kilowatt range (e.g. decrease load by 2.0 kW, restore 1.2-1.4 kW of previously reduced load). This may in turn be organised across more than one layer of hierarchy. For example, the operator may command a local substation box to shed 350 kW of load, and then the local substation box will instruct the individual loads how much they should shed.

Condition Level.

A command may be issued to the loads to go to a particular System Security Level (SSL). For example, SSL 0 means system security normal, no load restrictions; SSL 1 means system security is somewhat threatened in the next hour, switch off convenience loads; SSL 2 means system security is threatened in the next 10 minutes, remove all unessential loads.

Energy Prices.

A command may include current and projected future price signals to the consumer's load control system (e.g. current price is $0.05/kWh, prices for the next 3 hours will be $0.06/kWh, $0.10/kWh, and $0.08/kWh, respectively). The consumer then has an opportunity to program his load control system to respond to price as he sees fit.

Load Data.

Information may be returned from consumer's load control system to the operator (e.g. current load is 2.3 kW, curtailed load is 1.2 kW and awaiting restore command, 0.8 kW of additional convenience loads are available for curtailment). More than one level of hierarchy may also be applied here. Load levels may be summed at the substation, region, system, etc.

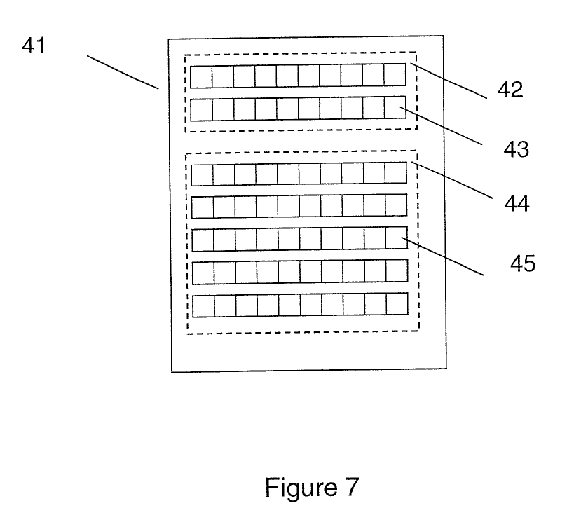

The signal 32 received from a local or remote authority 31 may be sent in a format compatible with Web based standards. In particular the signal, a data communication signal, is preferably compatible with XML, extensible Markup Language, the Extensible Style Language (XSL) standard, or a derivative thereof. Referring to FIG. 7, the schematic format for a data communication signal shown as 41 ordinarily comprises identifying data means 43 to identify a load point device 15. The indication for which data type 42 is included in the signal, such as XML, XSL or similar will ordinarily be indicated, and may be formatted separately from the data content 44. The data content 44 contained in the signal comprises data means 45 to invoke a remote procedure call to switch a second load on or off. This may be in the form of a signal such as switch signal 32 (FIG. 6).

The method described above and illustrated schematically in FIG. 6 is best carried out by one or more computer programs, or computer program products. The computer program product contains software portions and or computer program code elements for carrying out the steps and algorithms suitable for carrying out steps of the method according to the invention such as for calculations such as in steps 36-39 shown in FIG. 6.

Portable Load Management Embodiment

In another embodiment of the invention a load controlled by the system for load demand management may be supervised or controlled via an interface to the load point device by means of another computer, such as a portable computer. The portable computer may be located in a remote place or on site in the vicinity of the load point device. Communication may be established via a LAN connection, wired or wireless, to a power network control system and through that to the load point device.

In a development of the embodiment, direct contact may be made between an interface to the load point device and a computer remote or on site with the device. This may be a wired connection or a wireless communication between the load point device and a computer, portable computer, or portable computer as a handheld computing device. A wireless means compatible with a standard such as Bluetooth (Trade Mark), the wireless Ethernet standard IEEE 802.11b, wireless ATM (Asynchronous Transfer Mode) network standard IEEE 802.11a or the standard according to HomeRF in a suitable device or with a suitable plug-in card may be used to enable communication directly between the load point device and a computer so that an interface to the load point device may be accessed by the computer. Likewise it is possible to use an IR connection, compatible with IrDA (Infrared Data Association) standards for example, to establish a connection and access an interface to the load point device. By using a computer or a portable computer a person may carry out any of the following steps:

access an interface for a load point device,

receive a request for evidence of authorisation,

give evidence of authorisation,

select a monitoring action,

examine a state of a process monitored by the load point device,

select a control action,

change a shedding priority of a load or part load,

switch off or switch on a load.

In a yet further embodiment, a person such as a residential end user or an industrial or commercial end user employee may have limited authority to

check a status of one or more part loads,

alter load shedding status for a part load,

change a timing setting for shedding a part load,

change a price-related setting for a part load.

The price-related setting enables a consumer's electrical loads to react to offers from the power network for energy at a certain price at a certain time, shed loads at a certain price and time, restore them after a certain delay and so on.

In a further and preferred embodiment of the invention, the connection between a computer and the load point or an interface to the load point device may be established directly by direct connection by any of the following means or in whole or in part via a telephone. Telephone contact via a LAN or Internet provider to a web-based access is one method. Another method is to use, for example, a wireless means such as a Bluetooth (Trade Mark), IEEE 802.11b, or HomeRF device to enable communication via a telephone or modem to a private telephone network, a private or public cellular telephone network, wireless broadband networks such as the 3G type, wired broadband networks or an ordinary Public Switched Telephone Network (PSTN). It is also possible to communicate with the invention using paging systems, at least to the extent such that any information from the automated load management system may be communicated to a pager, and displayed on the pager display of a pager carried by a network operator, maintenance person, employee of an industrial/commercial consumer, or an individual consumer. More sophisticated pagers with two-way text sending facilities, such as two-way pagers for example of the type available from Motorola Inc., enable a signal to be returned to the automated load management system, such as to accept a new tariff or a special offer for a price/time/usage tariff, accept a load priority change and so on.

It is especially advantageous that an operator, power network employee or contractor or other person located at or remote from a distribution equipment site, may access an interface to a load point device by using a telephone arranged with Wireless Application Protocol (WAP) or I-Mode (or any similar protocol) capable of displaying data on a display of a telephone or other handheld computing device, and accepting input related to the display. By means of a display and an input means the person can perform for example the steps of the method described above and elsewhere in this description. This means that a person can examine information provided by the system and/or accessible via an interface to a load point device and carry out an action such as make a decision, change a priority, choose a price tariff or to carry out any aspect of the method of the invention by issuing an instruction. Input means for portable devices may include a keyboard, telephone touchpad, mouse, thumbwheel, slider, button or other arrangement for inputting a signal to a computing device or phone.

There are many handheld computing devices available that are arranged or may easily be arranged for wired and wireless communication. A Personal Data Assistant (PDA) product such as a Palm Pilot (Trade Mark) and Psion (Trade Mark) with IR (Infra Red) or telephone or Internet connection means may be used to access an interface to a load point device. By use of any of the above exemplary handheld means, a person may carry out any of the following actions:

access an interface for a load point device,

receive a request for evidence of authorisation,

give evidence of authorisation,

select a monitoring action,

examine a state of a process monitored by the load point device,

select a control action,

change a shedding priority of a load or part load,

switch off or switch on a part load.

The computer program products according to the invention may be stored at least in part in or on different mediums that are computer readable. Archive copies may be stored on standard magnetic disks, hard drives, CD or DVD disks, or magnetic tape. The databases and libraries are stored preferably on data servers, but the computer program products may, for example at different times, be stored in any of; a volatile Random Access memory (RAM) of a computer or processor, a hard drive, an optical or magneto-optical drive, or in a type of non-volatile memory such as a ROM, PROM, or EPROM device.

The reference means such as Consumption Table TAB shown in Tables 1-4 in tabular form, and in FIG. 6 as table 33 in step 35 in a look-up or database form, may be stored in a load point device or, alternatively, in another local device, by means of a memory such as of the RAM or hard disk type. The Consumption Table 33 may optionally be stored on a data server that is not local to the load point device.

The computer program product may also be arranged in part as a distributed application capable of running on several different computers or computer systems at more or less the same time.

What is claimed is:

1. A method to manage electrical demand automatically in an electrical power generation, transmission and distribution network (1) in which a characteristic of power supply for said electrical power network is determined and at least one first load is changed, comprising the steps of:
issuing a control signal to one or more load point devices (15) specifying a change in the value of the first load currently being consumed,
specifying in the control signal the magnitude of the change to be made in value of the first load currently being consumed,
specifying in the control signal that the load shall either be a decrease or an increase in magnitude,
calculating in the one or more load point devices which one or more of at least two second loads to change, where each second load forms a part of the first load,
providing a signal to switch at least one second load thereby changing the magnitude of the first load, which signal to switch the at least one second load comprises a means to invoke a remote procedure.

2. A method according to claim 1, further comprising the steps of:
calculating a value (kwtarget) for change in load (34) from a function of the load and a value for current consumption of the load,
determining the change to be a reduction in load, and
examining one or more second loads on a basis of priority for shedding,
calculating which second load or loads that when shed would most nearly match the target reduction (kWtarget).

3. A method according to claim 1, further comprising the steps of:
accessing a reference means (33) associated with a first load and determining one or more characteristics of a load including any of: magnitude of the load, a priority means assigned to the load, a status means assigned to the load that indicates when load is presently the subject of a load management action.

4. A method according to claim 3, further comprising the steps of:
switching off each second load identified to meet the reduction target (kWtarget), and
changing the status of the second load shown in a reference means to show that the second load has been disconnected as a result of a reduction signal.

5. A method according to claim 3, further comprising the steps of:
switching off each second load identified to meet the reduction target (kwtarget) in a predetermined order.

6. A method according to claim 1, wherein one or more second loads is a load or loads predetermined to be curtailable.

7. A method according to claim 1, wherein one or more second loads is a load specified to be all loads at the one or more load points.

8. A method according to claim 3, further comprising the steps of:
checking a status of one or more second loads,
altering load shedding status for a second load,
changing a timing setting for shedding a second load,
changing a price-related setting for a second load.

9. A method according to claim 1, wherein the signal comprises a control action to change the value of a load dependent on any of a fixed percentage amount, percentage range, fixed kilowatt amount, system condition level.

10. A method according to claim 1, wherein the means to invoke a remote procedure comprises a set of services compatible with an XML (extensible Markup Language) related standard such as SOAP (Simple Object Access Protocol) protocol.

11. A method according to claim 1, wherein the remote procedure invoked is implemented by means of an embedded controller in a load point device.

12. A method according to claim 11, further comprising the step of configuring the load point device.

13. A method according to claim 11, further comprising the steps of:
accessing an interface for a load point device,
receiving a request for evidence of authorisation,
giving evidence of authorisation,
selecting a monitoring action,
examining a state of a process monitored by the load point device,
selecting a control action,
changing a shedding priority of one or more second loads,
switching off or switching on a second load.

14. A method according to claim 1, wherein one or more steps are monitored using portable computer display means.

15. A method according to claim 1, wherein one or more steps are carried out using a portable computer to input an instruction.

16. A method according to claim 1, wherein one or more steps of said method are monitored using a telephone having means to display information.

17. A method according to claim 1, wherein one or more steps of said method are carried out using a telephone to input an instruction.

18. A method according to claim 1, wherein one or more steps of said method monitored using a paging device to display information.

19. A method according to claim 1, wherein one or more steps of said method are carried out using a paging device to input an instruction.

20. A method according to claim 2, further comprising the steps of:
determining the change to be a restoration of load, and
examining one or more second loads to identify loads that have been disconnected as a result of a reduction signal,
examining one or more second and disconnected loads on a basis of priority,
calculating which second load or loads that when reconnected on a priority basis would most nearly match the target for restoration (kWtarget).

21. A method according to claim 20, further comprising the step of switching on, in a predetermined order, each second load identified to meet the restoration target (kWtarget).

22. A system for managing loads automatically in an electrical power generation, transmission and distribution network (1), which comprises a device (15) arranged at one or more given electrical load points and arranged with means to receive a data communication, wherein the system comprises a plurality of load point devices that comprise a computer program product arranged to receive the data communication (32), identify whether a first load controlled by the load point device shall be decreased in magnitude and calculate which of one or more second loads forming a part of the first load shall be disconnected, wherein the computer program product is arranged to provide a signal to switch on or off one or more second loads with means which may be remotely invoked and which when so invoked result in the generation of a signal to switch off the second load.

23. A system according to claim 22, wherein the computer program product is provided with stored reference information (33) about one or more loads controlled by said load point device.

24. A system according to claim 23, wherein the stored reference information for the second load comprises a present magnitude of the second load, a status, a priority of disconnection and an indicator of whether the second load is the subject of a load management action.

25. A system according to claim 22, wherein the signal provided is arranged to switch off a plurality of second loads.

26. A system according to claim 22, wherein the load point device is comprised as one or more functions in one or more smart appliances (21, 22).

27. A system according to claim 22, wherein the means to receive a data communication are arranged with computer code means suitable to receive a data communication compatible with XML.

28. A system according to claim 22, wherein the computer program product includes means arranged to handle data means compatible with SOAP (Simple Object Access Protocol) protocol.

29. A system according to claim 22, wherein the load point device comprises Programmable Logic Controller.

30. A system according to claim 22, wherein the load point device comprises an embedded controller.

31. A system according to claim 22, wherein the load point device comprises a processor.

32. A system according to claim 22, wherein the load point device comprises a computer.

33. The system of claim 22, wherein the system regulates one or more electrical loads in a part of a power generation, transmission and distribution network.

34. The system of claim 22, wherein the system regulates one or more electrical loads in a part of a power generation, transmission and distribution network in order to meet a requirement dependent on a cost of electricity.

35. The system of claim 22, wherein the system is operated by a human operator to supervise and control management of electrical power demand in an electrical power distribution network.

36. The system of claim 22, wherein the system includes one or more computers to supervise, control, and manage electrical power demand in an electrical power distribution network.

37. The system of claim 22, wherein a data communication signal is included in a data transmission of said system, said system further comprising data means to invoke a remote procedure call to switch a second load on or off.

38. The system according to claim 37 wherein the data communication signal includes an instruction to change a load comprising information about the magnitude of the change and means to select a second load to be changed according to a predetermined selection of an order in which loads are to be disconnected and/or restored.

39. The system according to claim 37 wherein the data communication signal is comprised in a format compatible with XML.

40. The system according to claim 37 wherein the data communication signal further comprises an identity part to identify a given load point device (15).

41. The system according to claim 37 wherein the XML document contains a data part that is compatible with the SOAP protocol.

42. A computer program product containing software code portions or computer program elements which when said computer program product is run on any of a computer, a processor or a controller, would cause the computer, processor or controller to carry out the steps of a method according to claim 1.

43. A computer program product according to claim 42 included in a computer readable medium.
